(19) United States
(12) Patent Application Publication
(10) Pub. No.: US 2016/0375560 A1
(43) Pub. Date: Dec. 29, 2016

(54) RATCHET WRENCH

(71) Applicant: Jim LAI, Taiwan (CN)

(72) Inventor: Jim Lai, CHANGHUA CITY (TW)

(21) Appl. No.: 14/899,120

(22) PCT Filed: Mar. 19, 2014
(86) PCT No.: PCT/CN2014/073684

§ 371 Date: Dec. 16, 2015

(30) Foreign Application Priority Data
Jun. 19, 2013 (JP) 123

(51) Int. Cl. B25B 13/46; B25B 23/00

(52) U.S. Cl. CPC B25B 13/462; B25B 23/0007

(57) ABSTRACT

A ratchet wrench includes a driving unit located in the installation hole of the head. The driving unit has a ratchet seat with a driving hole. Multiple first teeth are defined in one of the top and the bottom of the ratchet seat. A ring is mounted to the ratchet seat and has second teeth which are engaged with the first teeth of the ratchet seat. A cover is mounted to the ratchet seat and located corresponding to the ring. A resilient member is biased between the cover and the ring so as to resiliently push the second teeth of the ring to be engaged with the first teeth of the ratchet seat. The first teeth move over the second teeth to generate sound to acknowledge the user the driving direction.

### BACKGROUND OF THE INVENTION

1. Fields of the invention

The present invention relates to a ratchet wrench, and more particularly, to a ratchet wrench which acknowledges the user the driving direction by sound generated by teeth of one part moving over teeth of another part.

2. Descriptions of Related Art

The conventional ratchet wrenches usually comprises head in which a driving member is rotatably received. The driving member has teeth defined in the outer periphery thereof A pawl is movably received in a recess of the head of the ratchet and is controlled by a biasing unit which is controlled by a control lever. The user operates the control lever to activate the biasing unit to move the pawl in the recess so as to be engage with the driving member to output torque to an object that is engaged with the driving member. The users need to check the driving direction often by checking the position that the control lever, or to check the marks on the body of the wrench. Alternatively, when using the wrench, the users may also randomly rotate the wrench in one direction to check if that direction is the driving direction to output torque. Some of the wrenches are designed to reduce the click sound when rotating the wrench in a direction that does not output torque. Nevertheless, the soundless design may confuse the users who cannot positively know which direction is the driving direction.

Another ratchet wrench reduces the width between the curved protrusion and the adjacent curved recess of at one end of the mounting hole of the driving member, and the curved protrusions each includes two inclined sides. By this way, the contact area between the object and the curved protrusions is increased so that the object can be effectively driven. However, the pawl is engaged with the teeth of the driving by limited number of teeth, so that when a significant output is to be output, the teeth of the pawl cannot bear the torque and may be worn out after frequent use.

The present invention intends to provide a ratchet wrench to eliminate the shortcomings mentioned above.

### SUMMARY OF THE INVENTION

The present invention relates to a ratchet wrench and comprises a head having an installation hole defined therethrough. A driving unit is located in the installation hole and has a ratchet seat, at least one ring, at least one resilient member and at least one cover. The ratchet seat has a driving hole defined through the top and the bottom thereof The ratchet seat has an outer periphery. Multiple first teeth are defined in one of the top and the bottom of the outer periphery of the ratchet seat. The at least one ring is mounted to the ratchet seat and has second teeth which are engaged with the first teeth of the ratchet seat. The at least one cover is mounted to the ratchet seat and located corresponding to the at least one ring. The at least one cover seals the installation hole in one of two sides of the head. The at least one resilient member is biased between the at least one cover and the at least one ring so as to resiliently push the second teeth of the at least one ring to be engaged with the first teeth of the outer periphery of the ratchet seat.

Preferably, the first teeth of the ratchet seat include multiple teeth which are located along the outer periphery of the ratchet seat. Each tooth is shaped as a right-angled triangle. The first teeth include multiple peaks and multiple valleys which are located alternatively to the peaks.

Preferably, a flange extends from one side of the at least one ring and the at least one resilient member is mounted to the flange.

Preferably, the installation hole has multiple curved recesses defined in the inner periphery thereof The at least one ring has multiple protrusions which are engaged with the curved recesses of the installation hole so as to restrict rotation of the at least one ring.

The present invention further provides another embodiment of the ratchet wrench and comprises a head having an installation hole defined therethrough. A driving unit is located in the installation hole and has a ratchet seat, two rings, two resilient members and two covers. The ratchet seat has a driving hole defined through the top and the bottom thereof The ratchet seat has an outer periphery. Multiple first teeth are defined in each of the top and the bottom of the outer periphery of the ratchet seat. The two rings are respectively mounted to the top and the bottom of the ratchet seat and each have second teeth which are engaged with the first teeth of the ratchet seat corresponding thereto. The two covers are respectively mounted to the top and the bottom of the head ratchet seat so as to seal the installation hole in two sides of the head. Each of the two resilient members is biased between the cover and the ring corresponding thereto so as to resiliently push the second teeth of the ring to be engaged with the first teeth of the outer periphery of the ratchet seat.

Preferably, the first teeth of the ratchet seat include multiple teeth which are located along the outer periphery of the ratchet seat. Each of the teeth is shaped as a right-angled triangle. The first teeth include multiple peaks and multiple valleys which are located alternatively to the peaks. The first teeth on the top and the bottom of the ratchet seat are located corresponding to each other.

Preferably, the first teeth of the ratchet seat include multiple teeth which are located along the outer periphery of the ratchet seat. Each of the teeth is shaped as a right-angled triangle. The first teeth include multiple peaks and multiple valleys which are located alternatively to the peaks. The first teeth on the top and the bottom of the ratchet seat are located alternatively to each other.

Preferably, a flange extends from one side of each of the rings. The resilient members are respectively mounted to the two flanges of the two rings.

Preferably, the installation hole of the head has two grooves defined in the inner periphery thereof and the two grooves are respectively located close to two ends of the installation hole. The two covers each have a slot defined in the outer periphery thereof Each of the two clips is engaged with the slot and the groove corresponding thereto.

Preferably, the installation hole has multiple curved recesses defined in the inner periphery thereof Each of the rings has multiple protrusions which are engaged with the curved recesses of the installation hole so as to restrict rotation of each of the rings.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet wrench of the present invention;

FIG. 2 is an exploded view of the ratchet wrench of the present invention;

FIG. 3 shows that the first teeth move over the second teeth of the ratchet wrench of the present invention;

FIG. 4 shows that the first teeth are engaged with the second teeth of the ratchet wrench of the present invention;

FIG. 5 is an exploded view of the second embodiment of the ratchet wrench of the present invention;

FIG. 6 shows that the first teeth move over the second teeth of the second embodiment of the ratchet wrench of the present invention;

FIG. 7 shows that the first teeth are engaged with the second teeth of the second embodiment of the ratchet wrench of the present invention;

FIG. 8 shows the third embodiment of the first teeth of the outer periphery of the ratchet seat of the ratchet wrench of the present invention, and

FIG. 9 shows the fourth embodiment of the first teeth of the outer periphery of the ratchet seat of the ratchet wrench of the present invention.

### DETAILED DESCRIPTION OF THE PREFERRED EMBODIMENT

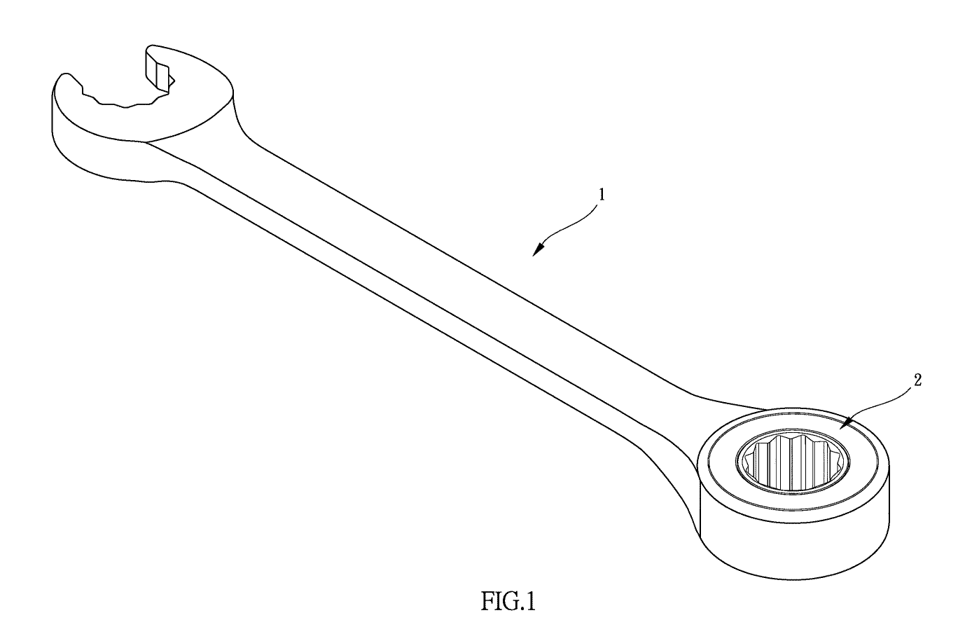

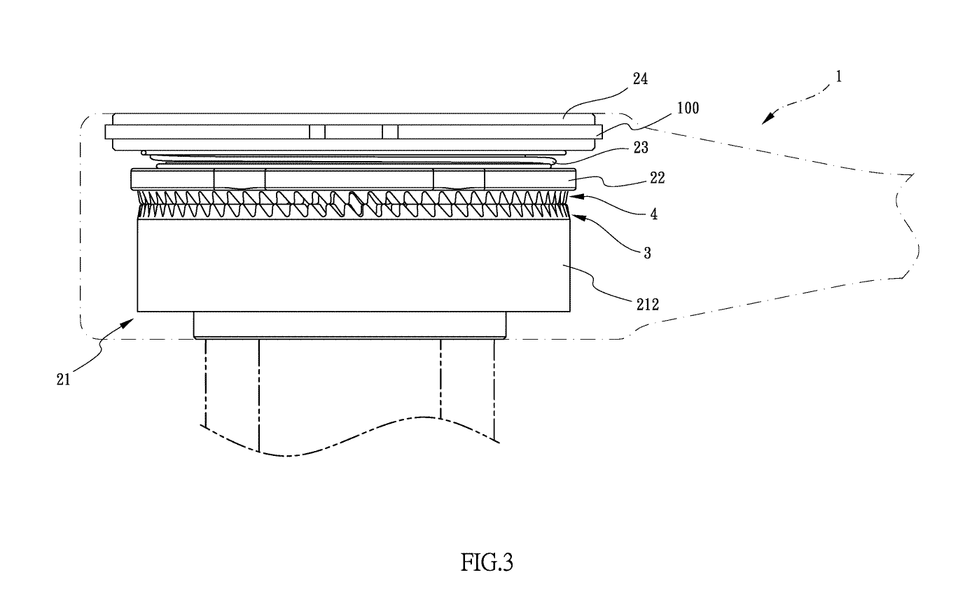

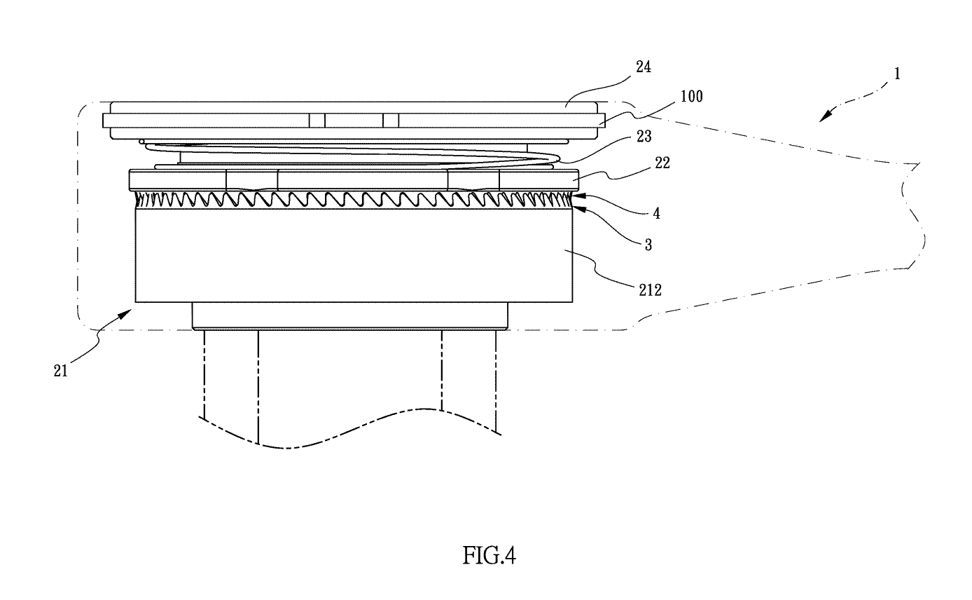

Referring to FIGS. 1 to 4, the first embodiment of the ratchet wrench 1 of the present invention comprises a head having an installation hole 11 defined therethrough. A driving unit 2 is located in the installation hole 11 and has a ratchet seat 21, a ring 22, a resilient member 23 and a cover 24. The ratchet seat 21 has a driving hole 211 defined through the top and the bottom thereof Multiple first teeth 3 are defined in one of the top and the bottom of the outer periphery 212 of the ratchet seat 21. The ring 2 is mounted to the ratchet seat 21 and has second teeth 4 which are engaged with the first teeth 3 of the ratchet seat 21. The cover 34 is mounted to the ratchet seat 21 and located corresponding to the ring 22. The cover 34 seals the installation hole 11 in one of two sides of the head. The resilient member 23 is biased between the cover 24 and the ring 22 so as to resiliently push the second teeth 4 of the ring 22 to be engaged with the first teeth 3 of the outer periphery 212 of the ratchet seat 21. The first and second teeth 3, 4 are able to be stably engaged with each other. Also, the first teeth 3 may move over the second teeth 4 to generate sound to acknowledge the user the driving direction. The weight of the ratchet wrench is also reduced, and the assembly is simplified.

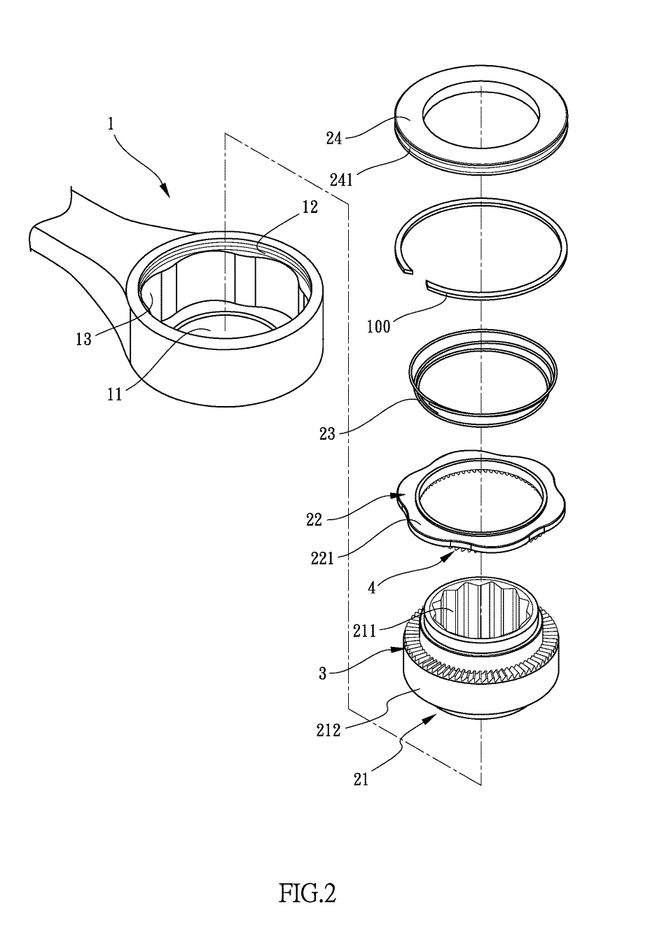

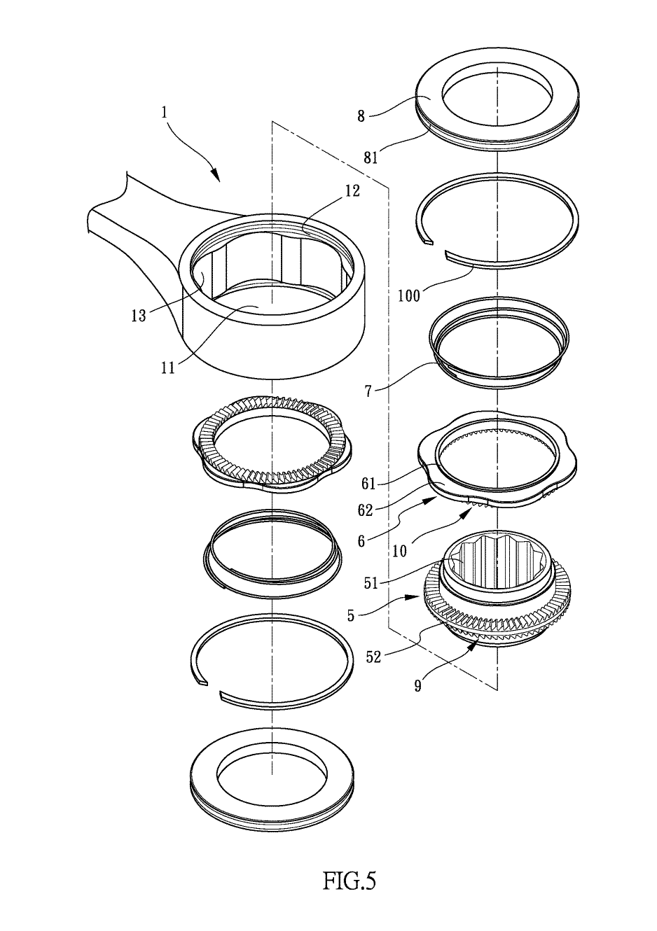

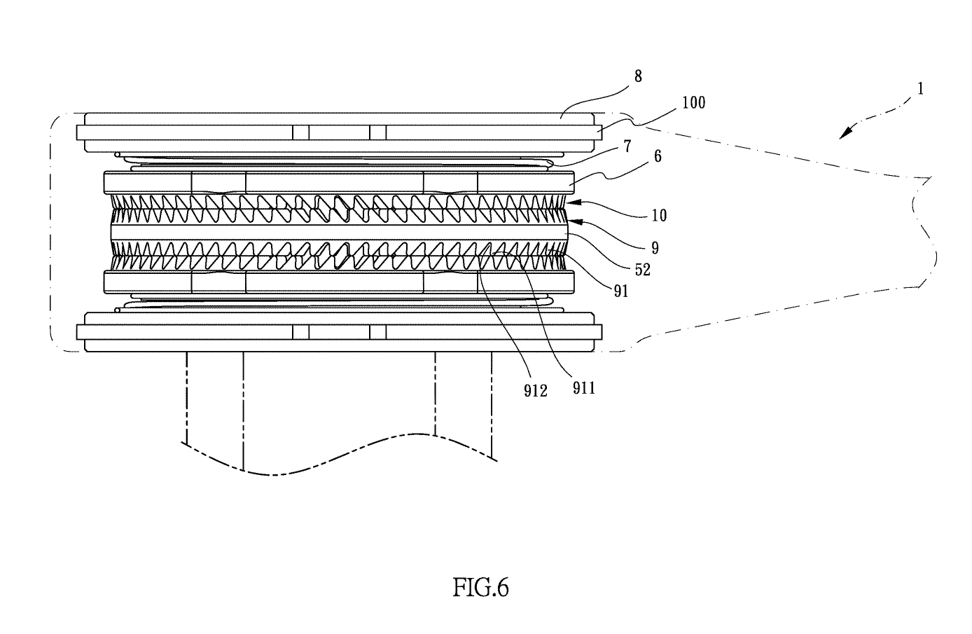

As shown in FIGS. 5 to 7, the second embodiment of the present invention is disclosed, the ratchet wrench 1 comprises a head having an installation hole 11 defined therethrough. A driving unit 2 is located in the installation hole 11 and has a ratchet seat 5, two rings 22, two resilient members 7 and two covers 8. The ratchet seat 5 has a driving hole 51 defined through the top and the bottom thereof The shape of the driving hole 51 disclosed in FIG. 2 may vary according needs. The ratchet seat 5 has an outer periphery 52. Multiple first teeth 9 are defined in each of the top and the bottom of the outer periphery 52 of the ratchet seat 5. The two rings 2 are respectively mounted to the top and the bottom of the ratchet seat 5 and each have second teeth 10 which are engaged with the first teeth 9 of the ratchet seat 5 corresponding thereto. The two covers 34 are respectively mounted to the top and the bottom of the head ratchet seat 5 so as to seal the installation hole 11 in two sides of the head. Each of the two resilient members 7 is biased between the cover 8 and the ring 6 corresponding thereto so as to resiliently push the second teeth 4 of the ring 6 to be engaged with the first teeth 9 of the outer periphery 52 of the ratchet seat 5.

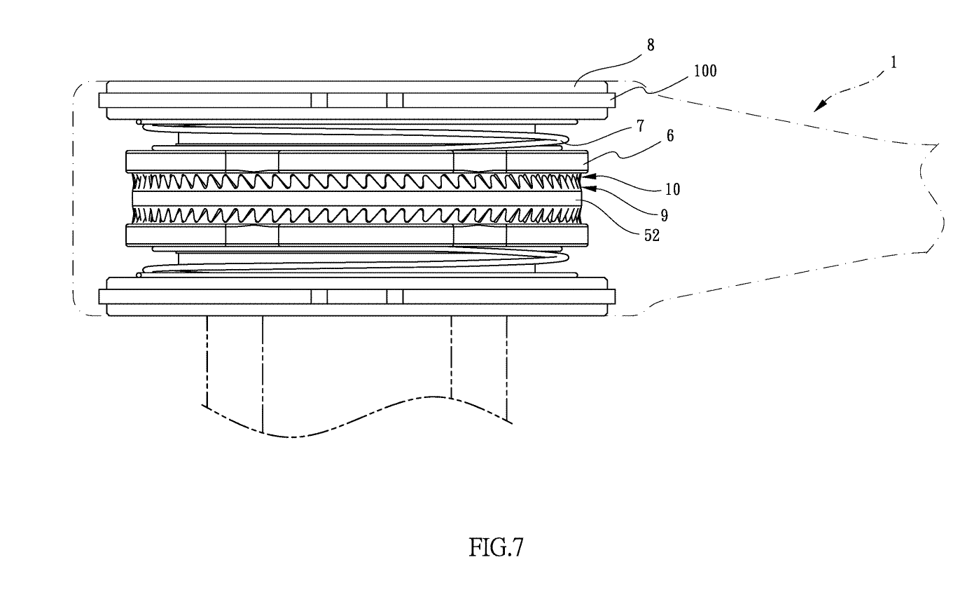

When using the second embodiment of the ratchet wrench 1 of the present invention, the resilient members 7 resiliently push the rings 6 toward the outer periphery 52 to engage the second teeth 10 on the rings 6 with the first teeth 9 of the outer periphery 52 stably. Because there are first teeth 9 on the top and bottom of the outer periphery 52 of the ratchet seat 5, so that the ratchet wrench 1 can be used on either side of the head to tighten or loosen objects. As shown in FIG. 7, by the engagement between the second teeth 10 on the rings 6 and the first teeth 9 of the outer periphery 52, the number of parts required and the weight of the ratchet wrench 1 are reduced. The assembling processes are also simplified as shown in FIGS. 5 to 7.

As shown in FIGS. 5 to 7, for the second embodiment of the present invention, the first teeth 9 on the outer periphery 52 of the ratchet seat 5 has two different designs, one of the designs is disclosed in FIG. 7, wherein the first teeth 9 of the ratchet seat 5 include multiple teeth 91 which are located along the outer periphery 52 of the ratchet seat 5. Each of the teeth 91 is shaped as a right-angled triangle. The first teeth 9 include multiple peaks 911 and multiple valleys 912 which are located alternatively to the peaks 911. The first teeth 91 on the top and the bottom of the ratchet seat 5 are located corresponding to each other. The peak 911 of each of the first teeth 9 on the top of the ratchet seat 5 is located corresponding to the peak 911 of each of the first teeth 9 on the bottom of the ratchet seat 5. The valley 912 of each of the first teeth 9 on the top of the ratchet seat 5 is located corresponding to the valley 912 of each of the first teeth 9 on the bottom of the ratchet seat 5. Therefore, the two rings 6 on the ratchet seat 5 are co-rotatable.

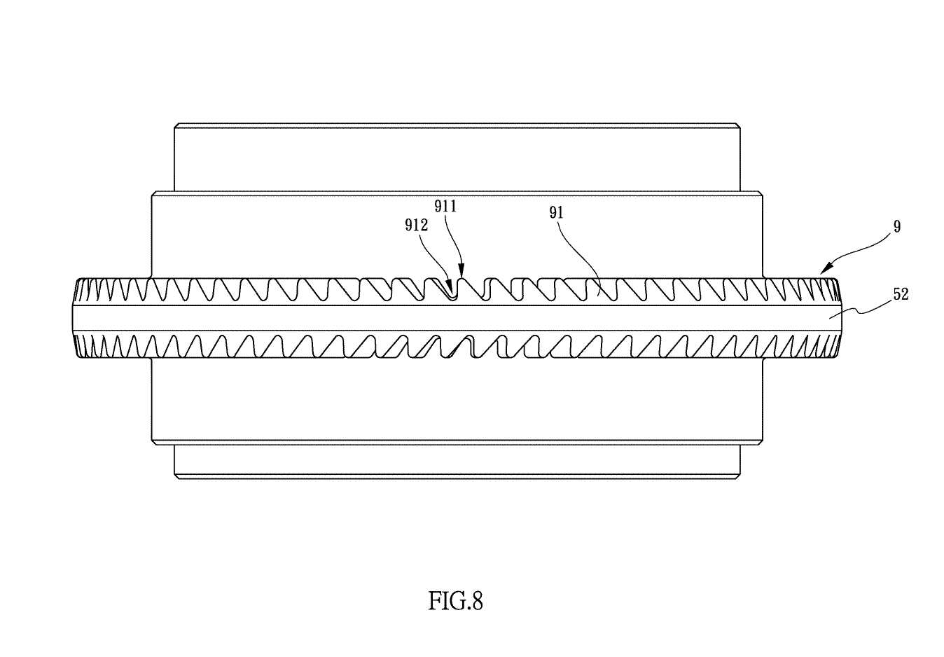

The other design is disclosed in FIG. 8, and the difference is that the first teeth 9 include multiple peaks 911 and multiple valleys 912 which are located alternatively to the peaks 911. The first teeth 91 on the top and the bottom of the ratchet seat 5 are located alternatively to each other. The peak 911 of each of the first teeth 9 on the top of the ratchet seat 5 is located corresponding to the valley 912 of each of the first teeth 9 on the bottom of the ratchet seat 5. The valley 912 of each of the first teeth 9 on the top of the ratchet seat 5 is located corresponding to the peak 911 of each of the first teeth 9 on the bottom of the ratchet seat 5. Therefore, when the first teeth 91 move over the second teeth 10, “click” sound is generated to acknowledge the user the driving direction.

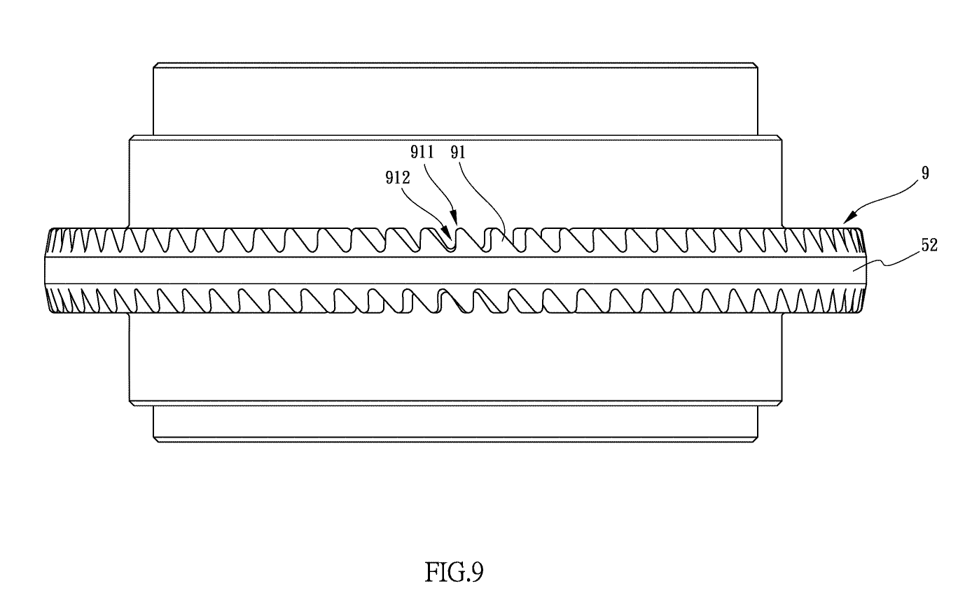

The two designs mentioned above may also have different options wherein the inclined side of each of the first teeth 9 on the top and the inclined side of each of the first teeth 9 on the bottom can be the same or different as shown in FIG. 9. The different option of the inclined side of each of the first teeth 9 changes the driving direction of the rings 6 but does not affect the operation. Besides, in order to ensure that the resilient members 7 on the top and bottom of the ratchet seat 5 to bounce back after the first teeth 9 move over the second teeth 10, and to prevent the resilient members 7 from jumping out to affect the engagement between eh rings 6 and the ratchet seat 5, an annular flange 61 extends from one side of each of the rings 6, and the resilient members 7 are respectively mounted to the two flanges 61 of the two rings 6. The outer periphery of each of the flanges 61 is perpendicular to the side of the ring 6 corresponding thereto, so that the resilient member 7 can be firmly mounted to the flange 61 without worry of jumping out when operating the ratchet wrench 1.

The conventional ratchet wrench has a cover connected to the head of the ratchet so that small parts do not drop out. However, the cover is connected to the head by screws which increase the weight of the ratchet.

Taken the second embodiment of the present invention as an example, the installation hole 11 of the head has two grooves 12 defined in the inner periphery thereof, and the two grooves 12 are respectively located close to two ends of the installation hole 11. The two covers 8 each have a slot 81 defined in the outer periphery thereof Each of the two clips 100 is engaged with the slot 81 and the groove 12 corresponding thereto. Therefore, the covers 8 seals the installation hole 11 and the parts in the head do not drop out. For the first embodiment, as shown in FIG. 5, the cover 24 has a slot 241 defined in the outer periphery thereof.

Furthermore, in order not to let the rings 6 rotate while the second teeth 10 are not precisely engaged with the first teeth 9, as shown in FIG. 5, the installation hole 11 has multiple curved recesses 13 defined in the inner periphery thereof Each of the rings 6 has multiple protrusions 62 which are engaged with the curved recesses 13 of the installation hole 11 so as to restrict rotation of each of the rings 22. By this way, the rings 6 do not rotate independently from the installation hole 11 to affect the engagement between the second teeth 10 and the first teeth 9. For the first embodiment, the installation hole 11 has multiple curved recesses 13 defined in the inner periphery thereof, and the ring 22 has multiple protrusions 221 which are engaged with the curved recesses 13 of the installation hole 11 so as to restrict rotation of the ring 22.

When using the ratchet wrench, the object can be tightened or loosened by rotating the ratchet seat 21, 5. The resilient members 23, 7 resiliently push the rings 22, 6 toward the ratchet seat 21, 5 so that the second teeth 4, 10 on the rings 22, 6 are engaged with the first teeth 3, 9 on the outer periphery 212, 52 so as to evenly bear the torque such that the first teeth 3, 9 and the second teeth 4, 10 have longer life of use. When the first teeth 3, 9 move over the second teeth 4, 10, “click” sound is generated to acknowledge the user the driving direction.

While we have shown and described the embodiment in accordance with the present invention, it should be clear to those skilled in the art that further embodiments may be made without departing from the scope of the present invention.

What is claimed is:

1. A ratchet wrench comprising:
a head having an installation hole defined therethrough, and
a driving unit located in the installation hole and having a ratchet seat, at least one ring, at least one resilient member and at least one cover, the ratchet seat having a driving hole defined through a top and a bottom thereof, the ratchet seat having an outer periphery, first teeth defined in one of a top and a bottom of the outer periphery of the ratchet seat, the at least one ring mounted to the ratchet seat and having second teeth which are engaged with the first teeth of the ratchet seat, the at least one cover mounted to the ratchet seat and located corresponding to the at least one ring, the at least one cover sealing the installation hole in one of two sides of the head, the at least one resilient member biased between the at least one cover and the at least one ring so as to resiliently push the second teeth of the at least one ring to be engaged with the first teeth of the outer periphery of the ratchet seat.

2. The ratchet wrench as claimed in claim 1, wherein the first teeth of the ratchet seat includes multiple teeth which are located along the outer periphery of the ratchet seat, each tooth of the first teeth is shaped as a right-angled triangle, the first teeth include multiple peaks and multiple valleys which are located alternatively to the peaks.

3. The ratchet wrench as claimed in claim 1, wherein a flange extends from one side of the at least one ring and the at least one resilient member is mounted to the flange.

4. The ratchet wrench as claimed in claim 1, wherein the installation hole has multiple curved recesses defined in an inner periphery thereof, the at least one ring has multiple protrusions which are engaged with the curved recesses of the installation hole so as to restrict rotation of the at least one ring.

5. A ratchet wrench 1 comprising:
a head having an installation hole defined therethrough, and
a driving unit located in the installation hole and having a ratchet seat, two rings, two resilient members and two covers, the ratchet seat having a driving hole defined through a top and a bottom thereof, the ratchet seat having an outer periphery, first teeth defined in each of a top and a bottom of the outer periphery of the ratchet seat, the two rings respectively mounted to the top and the bottom of the ratchet seat and each having second teeth which are engaged with the first teeth of the ratchet seat corresponding thereto, the two covers respectively mounted to the top and the bottom of the head ratchet seat so as to seal the installation hole in two sides of the head, each of the two resilient members biased between the cover and the ring corresponding thereto so as to resiliently push the second teeth of the ring to be engaged with the first teeth of the outer periphery 52 of the ratchet seat.

6. The ratchet wrench as claimed in claim 5, wherein the first teeth of the ratchet seat include multiple teeth which are located along the outer periphery of the ratchet seat, each of the teeth of the first teeth is shaped as a right-angled triangle, the first teeth include multiple peaks and multiple valleys which are located alternatively to the peaks, the first teeth on the top and the bottom of the ratchet seat are located corresponding to each other.

7. The ratchet wrench as claimed in claim 5, wherein the first teeth of the ratchet seat include multiple teeth which are located along the outer periphery of the ratchet seat, each of the teeth of the first teeth is shaped as a right-angled triangle, the first teeth include multiple peaks and multiple valleys which are located alternatively to the peaks, the first teeth on the top and the bottom of the ratchet seat are located alternatively to each other.

8. The ratchet wrench as claimed in claim 5, wherein a flange extends from one side of each of the rings, the resilient members are respectively mounted to the two flanges of the two rings.

9. The ratchet wrench as claimed in claim 5, wherein the installation hole of the head has two grooves defined in an inner periphery thereof and the two grooves are respectively located close to two ends of the installation hole, the two covers each have a slot defined in an outer periphery thereof, each of the two clips is engaged with the slot and the groove corresponding thereto.

10. The ratchet wrench as claimed in claim 5, wherein the installation hole has multiple curved recesses defined in an inner periphery thereof, each of the rings has multiple protrusions which are engaged with the curved recesses of the installation hole so as to restrict rotation of each of the rings.
